(19) United States
(12) Patent Application Publication
(10) Pub. No.: US 2018/0067363 A1
(43) Pub. Date: Mar. 8, 2018

(54) DISPLAY SUBSTRATE, DISPLAY PANEL, AND DISPLAY APPARATUS HAVING THE SAME

(71) Applicants: BOE TECHNOLOGY GROUP CO., LTD., Beijing (CN); PEKING UNIVERSITY, Beijing (CN)

(72) Inventors: Xinguo Li, Beijing (CN); Yi Wang, Beijing (CN); Xing Zhang, Beijing (CN); Yanbing Wu, Beijing (CN)

(73) Assignees: BOE TECHNOLOGY GROUP CO., LTD., Beijing (CN); PEKING UNIVERSITY, Beijing (CN)

(21) Appl. No.: 15/548,058

(22) PCT Filed: Dec. 16, 2016
(86) PCT No.: PCT/CN2016/110328

§ 371 Date: Aug. 1, 2017

(30) Foreign Application Priority Data
Feb. 5, 2016 (CN) 201610082370.3

(51) Int. Cl. G02F 1/1335; G02F 1/017

(52) U.S. Cl. CPC G02F 1/133621; G02F 1/017; G02F 2202/36; G02F 2001/01791; G02F 2203/055; G02F 2001/133614

(57) ABSTRACT

The present application discloses a display substrate having a base substrate, a quantum dot layer on the base substrate capable of emitting light of a first color when excited by light of a second color, and a light filtering layer for blocking at least a portion of the quantum dot layer from receiving light of the second color provided by ambient light.

### CROSS-REFERENCE TO RELATED APPLICATION

This application claims priority to Chinese Patent Application No. 201610082370.3, filed Feb. 5, 2016, the contents of which are incorporated by reference in the entirety.

### TECHNICAL FIELD

The present invention relates to display technology, more particularly, to a display substrate, a display panel, and a display apparatus having the same.

### BACKGROUND

Conventional display panels include a color filter substrate having a color filter layer therein. The conventional color filter layer is typically made of a resin material having a dye dispersed in the resin material. The conventional color filter layer absorbs light of one frequency range but transmits light of a different frequency range. Light transmittance through the conventional color filter layer is relatively low, e.g., about 30%. Due to the significant loss of light through the color filter layer, the conventional display panels are not energy-efficient.

### SUMMARY

In one aspect, the present invention provides a display substrate comprising a base substrate; a quantum dot layer on the base substrate capable of emitting light of a first color when excited by light of a second color, and a light filtering layer for blocking at least a portion of the quantum dot layer from receiving light of the second color provided by ambient light.

Optionally, the display substrate is configured so that the light of first color emitted from the at least a portion of the quantum dot layer transmits through the light filtering layer for image display.

Optionally, the display substrate is configured so that the quantum dot layer and the light filtering layer are arranged upstream and downstream, respectively, relative to each other along a light emitting direction of the display substrate.

Optionally, the light filtering layer and the base substrate are on different sides of the quantum dot layer.

Optionally, the light filtering layer and the base substrate are on a same side of the quantum dot layer.

Optionally, the light filtering layer on a side of the base substrate proximal to the quantum dot layer.

Optionally, the light filtering layer on a side of the base substrate distal to the quantum dot layer.

Optionally, the display substrate comprises at least a first subpixel area corresponding to a first subpixel, a second subpixel area corresponding to a second subpixel, and a third subpixel area corresponding to a third subpixel; and the quantum dot layer comprises a first light quantum dot block corresponding to the first subpixel area capable of emitting the light of first color when excited by the light of the second color, and a second light quantum dot block corresponding to the second subpixel area capable of emitting light of a third color when excited by the light of the second color.

Optionally, the light filtering layer is absent in an area corresponding to the third subpixel area.

Optionally, the light filtering layer in an area corresponding to the first subpixel and the second subpixel is an integral light filtering layer having a substantially uniform thickness.

Optionally, the light of the second color is blue light, the light filtering layer is a blue light filtering layer for selectively blocking blue light while allowing red light and green light passing through; the display substrate comprises at least a red subpixel area corresponding to a red subpixel, a green subpixel area corresponding to a green subpixel, and a blue subpixel area corresponding to a blue subpixel; and the quantum dot layer comprises a red light quantum dot block corresponding to the red subpixel area capable of emitting red light when excited by blue light, and a green light quantum dot block corresponding to the green subpixel are capable of emitting green light when excited by blue light.

Optionally, the blue light filtering layer is absent in an area corresponding to the blue subpixel area.

Optionally, the blue light filtering layer in an area corresponding to the red subpixel area and the green subpixel area is an integral light filtering layer having a substantially uniform thickness.

Optionally, the quantum dot layer further comprises a blue light quantum dot block corresponding to the blue subpixel area capable of emitting blue light when excited by blue light.

Optionally, the quantum dot layer is absent in an area corresponding to the blue subpixel area.

In another aspect, the present invention provides a display panel comprising a display substrate described herein.

In another aspect, the present invention provides a display panel comprising a first display substrate and a second display substrate facing each other; a quantum dot layer on the first display substrate capable of emitting light of a first color when excited by light of a second color; and a light filtering layer on the second display substrate for blocking at least a portion of the quantum dot layer from receiving light of the second color provided by ambient light.

Optionally, the display panel is configured so that the light of first color emitted from the at least a portion of the quantum dot layer transmits through the light filtering layer for image display.

Optionally, the display panel is configured so that the quantum dot layer and the light filtering layer are arranged upstream and downstream, respectively, relative to each other along a light emitting direction of the display substrate.

In another aspect, the present invention provides a display apparatus comprising a display panel described herein.

### BRIEF DESCRIPTION OF THE FIGURES

The following drawings are merely examples for illustrative purposes according to various disclosed embodiments and are not intended to limit the scope of the present invention.

FIGS. 1A-1G are diagrams illustrating the structure of a display panel in some embodiments.

FIG. 2 shows a light transmittance curve of a light filtering layer in some embodiments.

FIGS. 3A-3D are diagrams illustrating the structure of a display substrate in some embodiments.

FIGS. 4A-4D are diagrams illustrating the structure of a display substrate in some embodiments.

FIGS. 5A-5B are diagrams illustrating the structure of a light filtering layer in some embodiments.

### DETAILED DESCRIPTION

The disclosure will now describe more specifically with reference to the following embodiments. It is to be noted that the following descriptions of some embodiments are presented herein for purpose of illustration and description only. It is not intended to be exhaustive or to be limited to the precise form disclosed.

The present disclosure provides a novel display substrate, display panel and display apparatus that substantially obviates one or more of the problems due to limitations and disadvantages of the related art. As compared to the convention display substrate, display panel, and display apparatus, the present display substrate, display panel and display apparatus have a much higher light transmittance and a much higher display contrast.

In one aspect, the present disclosure provides a display panel having a first base substrate and a second base substrate facing each other. The display panel includes a quantum dot layer on the first base substrate capable of emitting light of a first color when excited by light of a second color; and a light source for image display on a side of the quantum dot layer distal to the first base substrate for providing the light of the second color to the quantum dot layer. Using quantum dot layer as the color generating component of the display panel is advantageous, as a quantum efficiency of more than 90% may be achieved, resulting in a significantly higher light utilization efficiency. However, as ambient light may also contain light of the second color (e.g., blue light) as a component, the quantum dot layer may be activated by the light of the second color provided by ambient light, resulting in a lower display contrast. Accordingly, the present display substrate, display panel and display apparatus further includes a light filtering layer for blocking at least a portion of the quantum dot layer from receiving light of the second color provided by ambient light, but does not significantly interfere excitation of the quantum dot layer by the light of the second color provided by the light source. For example, the light filtering layer may be configured to be between the quantum dot layer and incident ambient light external to the display panel. However, the light filtering layer is configured to be outside a space between the light source and the quantum dot layer. Optionally, the light filtering layer is configured to be outside a light path between the light source and the quantum dot layer. Any appropriate light source for image display may be used for making the present display panel. For example, in a liquid crystal display panel, the light source for image display may be a backlight. In a self-emitting display panel such as an organic light emitting display panel, the light source for image display may be a light emitting layer in the self-emitting display panel. Optionally, the light source emits a blue light. Optionally, the blue light emitted from the light source has a wavelength in the range of approximately 400 nm to approximately 500 nm, e.g., approximately 450 nm to approximately 495 nm. Optionally, the light filtering layer selectively blocks a blue light. Optionally, the light filtering layer selectively blocks a blue light having a wavelength in the range of approximately 400 nm to approximately 500 nm, e.g., approximately 450 nm to approximately 495 nm.

Various appropriate materials and methods may be practiced to make the light filtering layer. For example, the light filtering layer may be made of a material that selectively absorbs the light of the second color (e.g., blue light). Optionally, the light filtering layer may be made of a material that selectively reflects the light of the second color (e.g., blue light). A reflective type light filtering layer material may have any appropriate refractive index or light transmittance rate. Optionally, the reflective type light filtering layer is made of a material suitable for coating. The light filtering layer may have any appropriate thickness. Optionally, the light filtering layer has a thickness in the range of 10 μm to 10,000 μm, e.g., approximately 50 μm to approximately 5000 μm, approximately 500 μm to approximately 2500 μm, and approximately 1000 μm to approximately 2000 μm.

The light filtering layer may be made of an organic material, an inorganic material or a combination thereof. The light filtering layer material may be a material that absorbs the light of the second color (e.g., blue light), a material that reflects the light of the second color (e.g., blue light), or a material that interferes with the light of the second color (e.g., blue light). Optionally, the light filtering layer material is a material that absorbs and reflects, and optionally interferes with, the light of the second color (e.g., blue light). The light filtering layer material may have a multi-sublayer structure, each sublayer singly, or in combination with another sublayer, absorbs, reflects, or interferes with, the light of the second color. In some embodiments, the light filtering layer is made by co-depositing two materials having different refractive indexes (e.g., SiO₂ and TiO). In some embodiments, the light filtering layer is a multi-dielectric layer having multiple dielectric sublayers stacked together. Optionally, the multi-dielectric layer includes a sublayer having a higher refractive index and a sublayer having a lower refractive index stacked together. Optionally, the light filtering layer includes two inorganic dielectric sublayers, e.g., a SiNₓ sublayer and a SiOₓ sublayer stacked together. Optionally, the light filtering layer includes two transparent organic sublayers.

In some embodiments, one or more of the first base substrate and the second base substrate is a transparent base substrate. Optionally, the first base substrate is a transparent base substrate, and the incident ambient light external to the display panel irradiates into the display panel through the first base substrate, e.g., the incident ambient light external to the display panel is on a side of the first base substrate distal to the second base substrate. Optionally, the second base substrate is a transparent base substrate, and the incident ambient light external to the display panel irradiates into the display panel through the second base substrate, e.g., the incident ambient light external to the display panel is on a side of the second base substrate distal to the first base substrate.

In some embodiments, the first base substrate is a transparent base substrate; the light filtering layer is on a side of the quantum dot layer distal to the light source for image display. Optionally, the light filtering layer is on a side of the transparent base substrate proximal to the quantum dot layer. Optionally, the light filtering layer is on a side of the transparent base substrate distal to the quantum dot layer.

In some embodiments, the second base substrate is a transparent base substrate, the light source is a light emitting layer between the first base substrate and the second base substrate; the light filtering layer is on the second base substrate and on a side of the light emitting layer distal to the quantum dot layer. Optionally, the light filtering layer is on a side of the transparent base substrate proximal to the quantum dot layer. Optionally, the light filtering layer is on a side of the transparent base substrate distal to the quantum dot layer.

In some embodiments, the display panel may include a plurality of subpixels in each pixel, e.g., a first subpixel, a second subpixel, and a third subpixel. In some display panels, the quantum dot layer may include a plurality of quantum dot blocks, e.g., a first light quantum dot block corresponding to the first subpixel capable of emitting the light of the first color when excited by the light of the second color; and a second light quantum dot block corresponding to the second subpixel capable of emitting light of a third color when excited by the light of the second color. Optionally, the quantum dot layer further includes a third light quantum dot block corresponding to the third subpixel capable of emitting light of a second color when excited by the light of the second color. Optionally, the display panel does not include a third light quantum dot block corresponding to the third subpixel. Optionally, the display panel includes a light transmissive region in the region corresponding to the quantum dot layer in the third subpixel. The light transmissive region may be a transparent resin layer or an empty space.

In some embodiments, the light filtering layer is configured between the incident ambient light external to the display panel and the first light quantum dot block, and between the incident ambient light external to the display panel and the second light quantum dot block. The light filtering layer is limited to areas corresponding to subpixels other than the third subpixel, e.g., the light filtering layer is absent in an area corresponding to the third subpixel.

Optionally, the light filtering layer in an area corresponding to the first subpixel and the second subpixel is an integral light filtering layer having a substantially uniform thickness. Optionally, the light filtering layer may include a plurality of light filtering blocks spaced apart from each other. For example, the light filtering layer may include a first light filtering block in an area corresponding to the first subpixel, and a second light filtering block in an area corresponding to the second subpixel, the first light filtering block and the second light filtering block spaced apart from each other.

In some embodiments, the first color, the second color and the third color are three different colors selected from red, green and blue. In some embodiments, the second color is blue, the first color is red and the third color is green. In some embodiments, the quantum dot layer includes a red light quantum dot block corresponding to the red subpixel capable of emitting red light when excited by blue light; a green light quantum dot block corresponding to the green subpixel capable of emitting green light when excited by blue light; and a blue light filtering layer for selectively blocking blue light while allowing red light and green light passing through. Optionally, the quantum dot layer further includes a blue light quantum dot block corresponding to the blue subpixel capable of emitting blue light when excited by blue light. Optionally, the display panel does not include a blue light quantum dot block corresponding to the blue subpixel, e.g., blue light emits from the blue subpixel without passing through the quantum dot layer. Optionally, the display panel includes a light transmissive region in the region corresponding to the quantum dot layer in the third subpixel. The light transmissive region may be a transparent resin layer or an empty space.

In some embodiments, the blue light filtering layer is configured between the incident ambient light external to the display panel and the red light quantum dot block, and between the incident ambient light external to the display panel and the green light quantum dot block. The blue light filtering layer is limited to areas corresponding to subpixels other than the blue subpixel, e.g., the blue light filtering layer is absent in an area corresponding to the blue subpixel.

Optionally, the blue light filtering layer in an area corresponding to the red subpixel and the green subpixel is an integral light filtering layer having a substantially uniform thickness. Optionally, the blue light filtering layer may include a plurality of blue light filtering blocks spaced apart from each other. For example, the blue light filtering layer may include a first blue light filtering block in an area corresponding to the red subpixel, and a second blue light filtering block in an area corresponding to the green subpixel, the first blue light filtering block and the second blue light filtering block spaced apart from each other.

In one aspect, the present disclosure provides a display substrate having both a quantum dot layer and a light filtering layer. In some embodiments, the display substrate includes a base substrate; a quantum dot layer on the base substrate capable of emitting light of a first color when excited by light of a second color; and a light filtering layer for blocking at least a portion of the quantum dot layer from receiving light of the second color provided by ambient light; the light filtering layer and the base substrate on a same side of the quantum dot layer. Optionally, the light filtering layer is on a side of the quantum dot layer proximal to a display side of the display substrate. Optionally, the light filtering layer on a side of the base substrate proximal to the quantum dot layer. Optionally, the light filtering layer on a side of the base substrate distal to the quantum dot layer.

As used herein, the term “display side” refers to a side of the display substrate facing a viewer during image display, when the display substrate is assembled into a display panel. Optionally, the display side is a same side from which ambient light irradiates into the display panel.

In some embodiments, the display substrate may include a plurality of subpixel areas in each pixel area, e.g., a first subpixel area, a second subpixel area, and a third subpixel area. In some display substrates, the quantum dot layer may include a plurality of quantum dot blocks, e.g., a first light quantum dot block corresponding to the first subpixel area capable of emitting the light of the first color when excited by the light of the second color; and a second light quantum dot block corresponding to the second subpixel area capable of emitting light of a third color when excited by the light of the second color. Optionally, the quantum dot layer further includes a third light quantum dot block corresponding to the third subpixel area capable of emitting light of a second color when excited by the light of the second color. Optionally, the display substrate does not include a third light quantum dot block corresponding to the third subpixel area. Optionally, the display substrate includes a light transmissive region in the region corresponding to the quantum dot layer in the third subpixel area. The light transmissive region may be a transparent resin layer or an empty space.

The light filtering layer is limited to areas corresponding to subpixel areas other than the third subpixel area, e.g., the light filtering layer is absent in an area corresponding to the third subpixel area.

Optionally, the blue light filtering layer in an area corresponding to the red subpixel area and the green subpixel area is an integral light filtering layer having a substantially uniform thickness. Optionally, the blue light filtering layer may include a plurality of blue light filtering blocks spaced apart from each other. For example, the blue light filtering layer may include a first blue light filtering block in an area corresponding to the red subpixel area, and a second blue light filtering block in an area corresponding to the green subpixel area, the first light filtering block and the second light filtering block spaced apart from each other.

In some embodiments, the first color, the second color and the third color are three different colors selected from red, green and blue. In some embodiments, the second color is blue, the first color is red and the third color is green. In some embodiments, the quantum dot layer includes a red light quantum dot block corresponding to the red subpixel area capable of emitting red light when excited by blue light; a green light quantum dot block corresponding to the green subpixel area capable of emitting green light when excited by blue light; and a blue light filtering layer for selectively blocking blue light while allowing red light and green light passing through. Optionally, the quantum dot layer further includes a blue light quantum dot block corresponding to the blue subpixel area capable of emitting blue light when excited by blue light. Optionally, the display substrate does not include a blue light quantum dot block corresponding to the blue subpixel area, e.g., blue light emits from the blue subpixel area without passing through the quantum dot layer. Optionally, the display panel includes a light transmissive region in the region corresponding to the quantum dot layer in the third subpixel area. The light transmissive region may be a transparent resin layer or an empty space.

The blue light filtering layer is limited to areas corresponding to subpixel areas other than the blue subpixel area, e.g., the blue light filtering layer is absent in an area corresponding to the blue subpixel area.

Optionally, the blue light filtering layer in an area corresponding to the red subpixel area and the green subpixel area is an integral light filtering layer having a substantially uniform thickness. Optionally, the blue light filtering layer may include a plurality of blue light filtering blocks spaced apart from each other. For example, the blue light filtering layer may include a first blue light filtering block in an area corresponding to the red subpixel area, and a second blue light filtering block in an area corresponding to the green subpixel area, the first light filtering block and the second light filtering block spaced apart from each other.

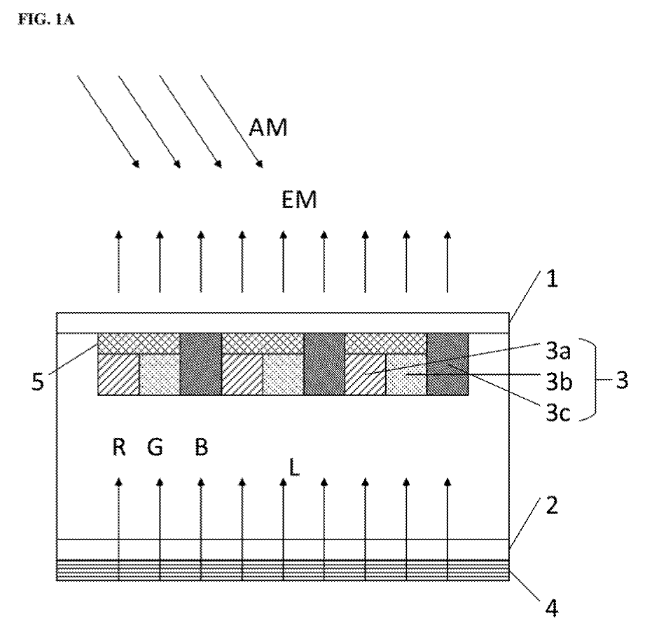

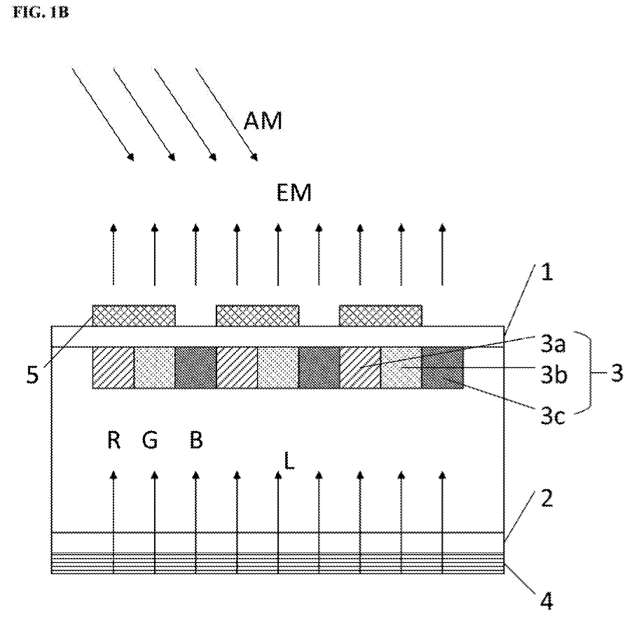

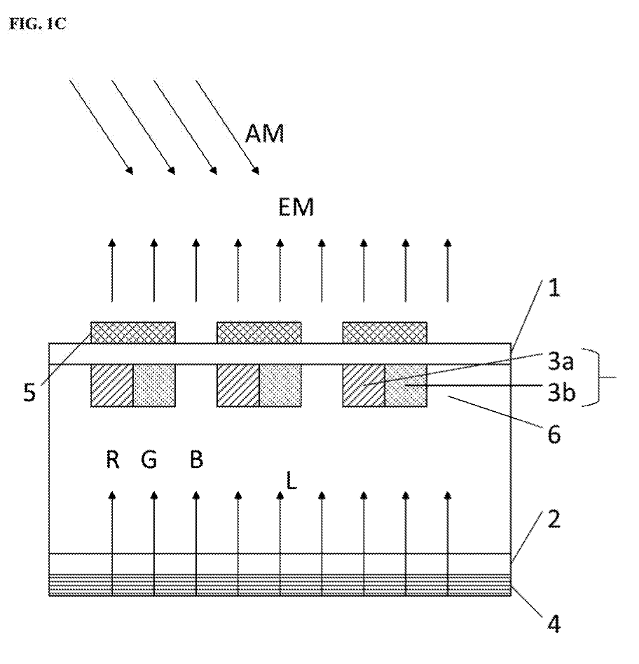

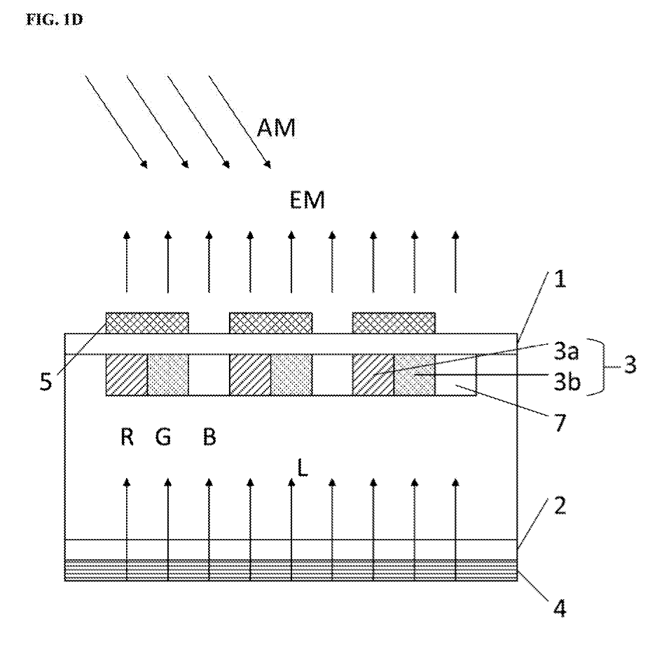

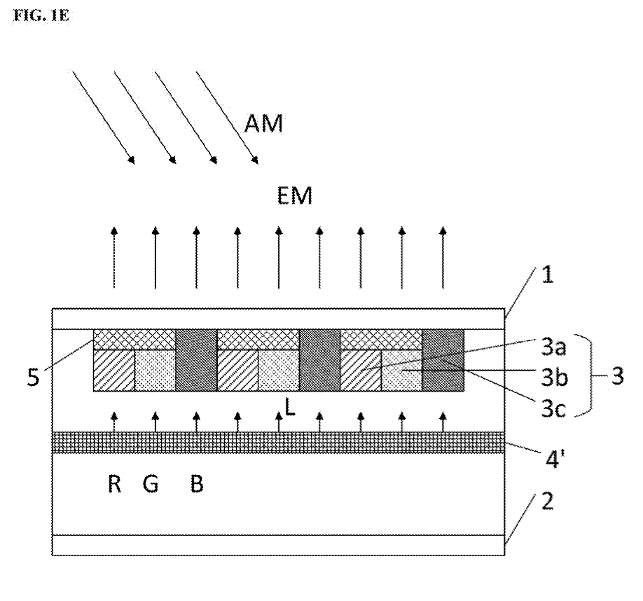

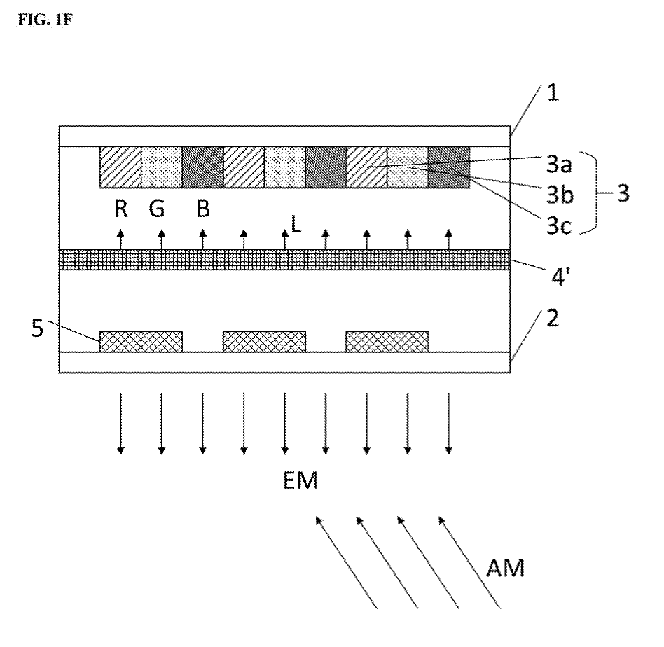

FIGS. 1A-1G are diagrams illustrating the structure of a display panel in some embodiments. Referring to FIG. 1A, the display panel in the embodiment includes a first base substrate 1 and a second base substrate 2 facing each other. The display panel includes, between the first base substrate 1 and the second base substrate 2, a quantum dot layer 3 on the first base substrate 1 capable of emitting light of a first color when excited by light of a second color. The quantum dot layer 3 in FIG. 1A includes a plurality of quantum dot blocks 3a, 3b, and 3c, each of which corresponding to a subpixel in the display panel. FIG. 1A illustrates a plurality of pixels of the display panel, each pixel includes a red subpixel R, a green subpixel G, and a blue subpixel B. The first quantum dot block 3a corresponds to the red subpixel R, the second quantum dot block 3b corresponds to the green subpixel G, and the third quantum dot block 3c corresponds to the blue subpixel B.

The display panel in FIG. 1A is a liquid crystal display panel including a backlight 4 on a side of the second base substrate 2 distal to the first base substrate 1. The backlight 4 emits light L into the display panel for image display. In FIG. 1A, the first base substrate 1 is a transparent base substrate. The first base substrate side of the display panel is the display side EM. As shown in FIG. 1A, light of displayed image emits from the display side EM of the display panel. The ambient light AM irradiates into the display panel also from the display side EM of the display panel.

Referring to FIG. 1A, the display panel in the embodiment further includes a light filtering layer 5 for blocking at least a portion of the quantum dot layer 3 from receiving light of the second color provided by ambient light. The light filtering layer 5 is configured between the quantum dot layer 3 and incident ambient light external to the display panel.

The first quantum dot block 3a is capable of emitting red light when excited by blue light, the second quantum dot block 3b is capable of emitting green light when excited by blue light, and the third quantum dot block 3c is capable of emitting blue light when excited by blue light. The light source emits light L having blue light as a component. For example, the light L may be a white light. Optionally, the light L is a blue light for achieving a higher light utilization efficiency.

Typically, ambient light AM is a white light having blue light as a component. Thus, when ambient light AM irradiates on the quantum layer, it may excite the quantum layer to emit a red light or a green light, resulting in a lower display contrast. Accordingly, the present display panel includes a light filtering layer 5 between the incident ambient light AM external to the display panel and the quantum light layer 3. The light filtering layer 5 selectively blocks blue light in the incident ambient light AM from reaching the quantum dot layer 3.

Because the light filtering layer 5 blocks blue light, the light filtering layer 5 may not be disposed between the light source 4 and the quantum dot layer 3 as blue light from the light source 4 is needed for excitation of the quantum dot layer 3. For example, the light filtering layer 5 may not block a light path between the light source 4 and the quantum dot layer 3. Accordingly, as shown in FIG. 1A, the light filtering layer 5 is disposed on a side of the quantum dot layer 3 distal to the light source 4, e.g., on a side of the quantum dot layer 3 proximal to the display side EM of the display panel.

In FIG. 1A, the light filtering layer 5 in an area corresponding to the red subpixel R and the green subpixel G is an integral light filtering layer having a substantially uniform thickness. The light filtering layer 5 is absent in an area corresponding to the blue subpixel B. Optionally, the light filtering layer 5 may include a plurality of light filtering blocks spaced apart from each other. For example, the light filtering layer 5 may include a first light filtering block in an area corresponding to the red subpixel, and a second light filtering block in an area corresponding to the green subpixel, the first light filtering block and the second light filtering block spaced apart from each other.

In FIG. 1A, the light filtering layer 5 is on a side of the transparent first base substrate 1 proximal to the quantum dot layer 3. Referring to FIG. 1B, the light filtering layer 5 may be on a side of the transparent first base substrate 1 distal to the quantum dot layer 3. In fabricating a display panel of FIG. 1B, the light filtering layer 5 may be conveniently attached to the display side surface of the display panel.

In FIG. 1A, the quantum dot layer 3 includes a blue light quantum dot block 3c in an area corresponding to the blue subpixel B. Optionally, the quantum dot layer 3 does not include a blue light quantum dot block, and the blue light emits from the blue subpixel without passing through a quantum light layer. Referring to FIG. 1C, the display panel may have an empty space 6 in an area corresponding to the quantum dot layer 3 in the blue subpixel B. Because the emitted blue light is directly from the light source without any conversion by a quantum dot layer, blue light utilization efficiency in the blue subpixel may be improved. Referring to FIG. 1D, the display panel may include a transparent block 7 in an area corresponding to the quantum dot layer 3 in the blue subpixel B. The transparent block 7 has a thickness that is substantially the same as that of the quantum light layer 3 (e.g., the red quantum light block 3a and the green quantum light block 3b). By having a transparent block 7 in the blue subpixel, a more passivatized layer structure may be achieved.

FIG. 1E shows a self-emitting display panel such as a top-emitting organic light emitting display panel. In FIG. 1E, the display panel includes a light emitting layer 4′ as the light source for image display, disposed between the first base substrate 1 and the second base substrate 2. The first base substrate 1 is a transparent base substrate. The light emitting layer 4′ is one a side of the quantum dot layer 3 distal to the first base substrate 1. The light filtering layer 5 is on a side of the quantum dot layer 3 distal to the light emitting layer 4′, e.g., on a side of the quantum dot layer 3 proximal to the display side EM of the display panel. In FIG. 1E, the light filtering layer 5 is on a side of the transparent first base substrate 1 proximal to the quantum dot layer 3. Optionally, the light filtering layer 5 may be on a side of the transparent first base substrate 1 distal to the quantum dot layer 3.

FIG. 1F shows a self-emitting display panel such as a bottom-emitting organic light emitting display panel. In FIG. 1F, the display panel includes a light emitting layer 4′ as the light source for image display, disposed between the first base substrate 1 and the second base substrate 2. The second base substrate 2 is a transparent base substrate. The light filtering layer 5 is on the second base substrate and on a side of the light emitting layer 4′ distal to the quantum dot layer 3. In FIG. 1F, the light filtering layer 5 is on a side of the transparent second base substrate proximal to the quantum dot layer 3 (or the light emitting layer 4′). Referring to FIG. 1G, the light filtering layer 5 may be disposed on side of the transparent second base substrate distal to the quantum dot layer 3 (or the light emitting layer 4′).

FIG. 2 shows a light transmittance curve of a light filtering layer in some embodiments. Referring to FIG. 2, the light filtering layer selectively blocks a blue light having a wavelength in the range of x nm to y nm. Optionally, the range of x nm to y nm substantially overlaps with a blue light wavelength range, e.g., approximately 400 nm to approximately 500 nm. The light filtering layer in FIG. 2 substantially does not block light having a wavelength of more than y nm. Moreover, as shown in FIG. 2, the light filtering layer has relatively low absorption for red light (e.g., 620 nm to 750 nm) and green light (e.g., 495 nm to 570 nm).

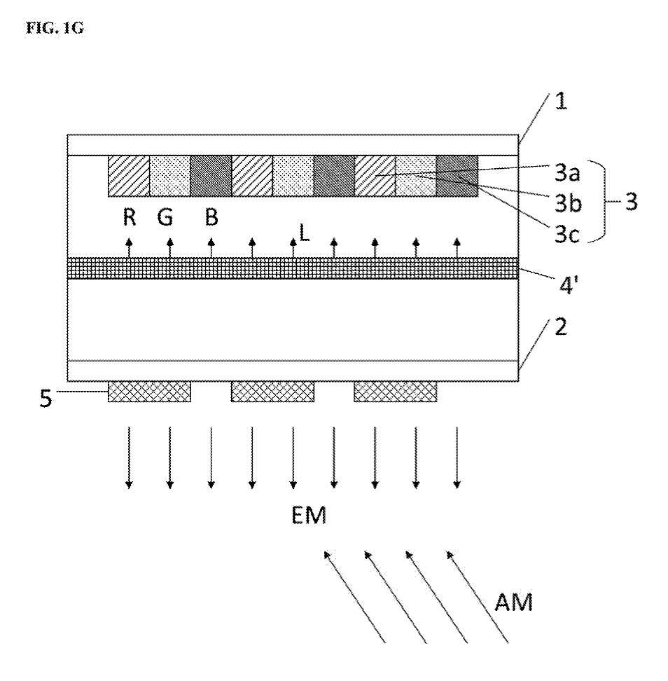

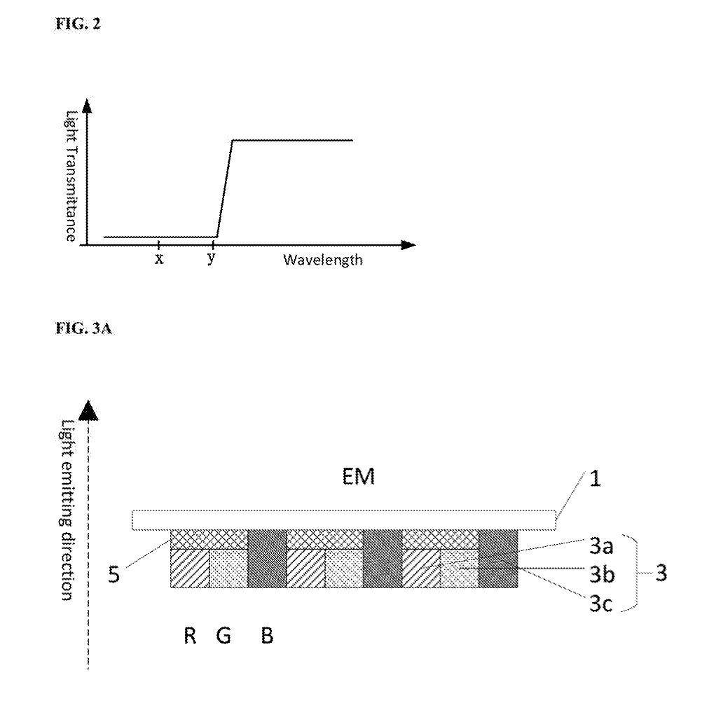

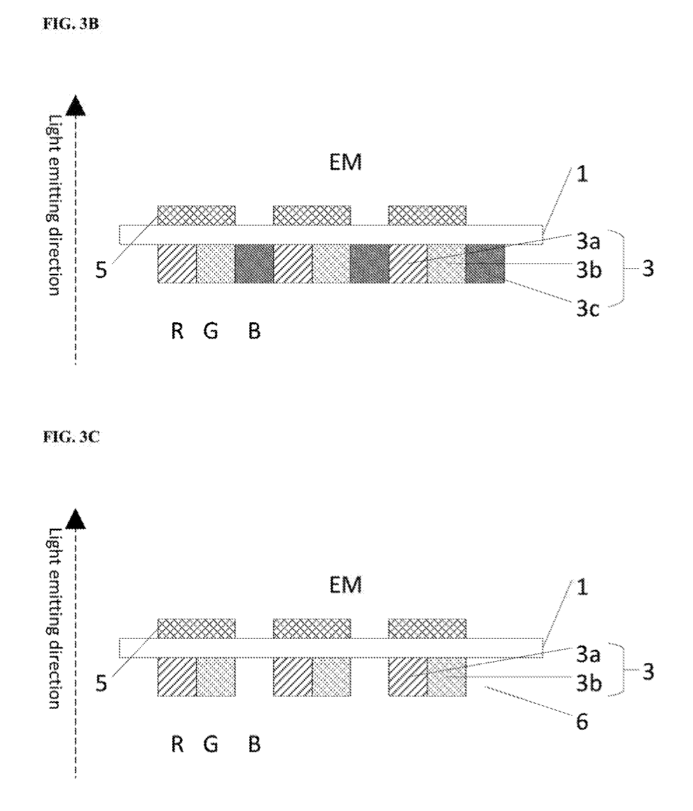

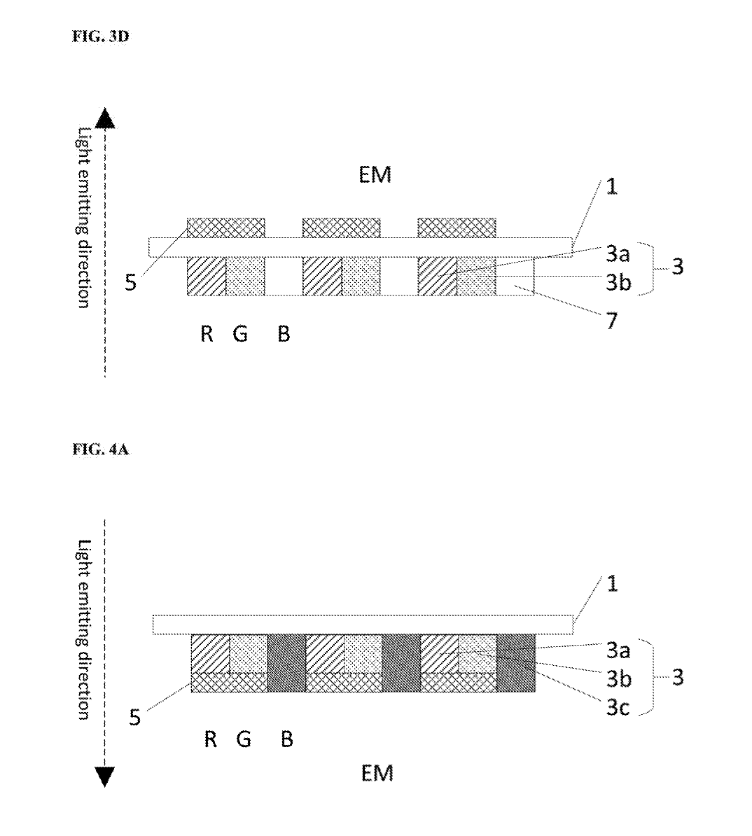

FIGS. 3A-3D are diagrams illustrating the structure of a display substrate in some embodiments. Referring to FIG. 3A, the display substrate in the embodiment includes a base substrate 1, a quantum dot layer 3 on the base substrate 1 capable of emitting light of a first color when excited by light of a second color, and a light filtering layer 5 for blocking at least a portion of the quantum dot layer 3 from receiving light of the second color provided by ambient light. As shown in FIG. 3A, the light filtering layer 5 and the base substrate 1 on a same side of the quantum dot layer. In FIG. 3A, the base substrate 1 is a transparent base substrate configured to be disposed on a display side EM of a display panel having the display substrate. Light of display image would emit from the display side EM of so formed display panel. Ambient light irradiates into the so formed display panel from the display side EM. The light filtering layer 5 is configured between the quantum dot layer 3 and incident ambient light external to the display panel.

The quantum dot layer 3 in FIG. 3A includes a plurality of quantum dot blocks 3a, 3b, and 3c, each of which corresponding to a subpixel area in the display substrate. FIG. 3A illustrates a plurality of pixel areas of the display substrate, each pixel area includes a red subpixel area R, a green subpixel area G, and a blue subpixel area B. The first quantum dot block 3a corresponds to the red subpixel area R, the second quantum dot block 3b corresponds to the green subpixel area G, and the third quantum dot block 3c corresponds to the blue subpixel area B. The first quantum dot block 3a is capable of emitting red light when excited by blue light, the second quantum dot block 3b is capable of emitting green light when excited by blue light, and the third quantum dot block 3c is capable of emitting blue light when excited by blue light.

In FIG. 3A, the light filtering layer 5 in an area corresponding to the red subpixel area R and the green subpixel area G is an integral light filtering layer having a substantially uniform thickness. The light filtering layer 5 is absent in an area corresponding to the blue subpixel area B. Optionally, the light filtering layer 5 may include a plurality of light filtering blocks spaced apart from each other. For example, the light filtering layer 5 may include a first light filtering block in an area corresponding to the red subpixel area, and a second light filtering block in an area corresponding to the green subpixel area, the first light filtering block and the second light filtering block spaced apart from each other.

In FIG. 3A, the light filtering layer 5 is on a side of the base substrate 1 proximal to the quantum dot layer 3. Referring to FIG. 3B, the light filtering layer 5 may be on a side of the base substrate 1 distal to the quantum dot layer 3. In fabricating a display substrate of FIG. 3B, the light filtering layer 5 may be conveniently attached to the display side surface of the display substrate.

In FIG. 3A, the quantum dot layer 3 includes a blue light quantum dot block 3c in an area corresponding to the blue subpixel area B. Optionally, the quantum dot layer 3 does not include a blue light quantum dot block, and the blue light emits from the blue subpixel without passing through a quantum light layer. Referring to FIG. 3C, the display substrate may have an empty space 6 in an area corresponding to the quantum dot layer 3 in the blue subpixel area B. In a display panel having the display substrate of FIG. 3C, the emitted blue light is directly from the light source without any conversion by a quantum dot layer, blue light utilization efficiency in the blue subpixel may be improved. Referring to FIG. 3D, the display substrate may include a transparent block 7 in an area corresponding to the quantum dot layer 3 in the blue subpixel area B. The transparent block 7 has a thickness that is substantially the same as that of the quantum light layer 3 (e.g., the red quantum light block 3a and the green quantum light block 3b). By having a transparent block 7 in the blue subpixel, the more passivatized layer structure may be achieved.

As shown in FIGS. 3A-3D, the display substrate is configured so that the light of first color emitted from the at least a portion of the quantum dot layer 3 (e.g., the first quantum dot block 3a and the second quantum dot block 3b) transmits through the light filtering layer 5 for image display. The display substrate is configured so that the quantum dot layer 3 and the light filtering layer 5 are arranged upstream and downstream, respectively, relative to each other along a light emitting direction of the display substrate. The light filtering layer 5 is disposed on a side of the quantum dot layer 3 proximal to the display side EM of the display substrate. Optionally, the display substrate in FIGS. 3A-3D is a counter substrate.

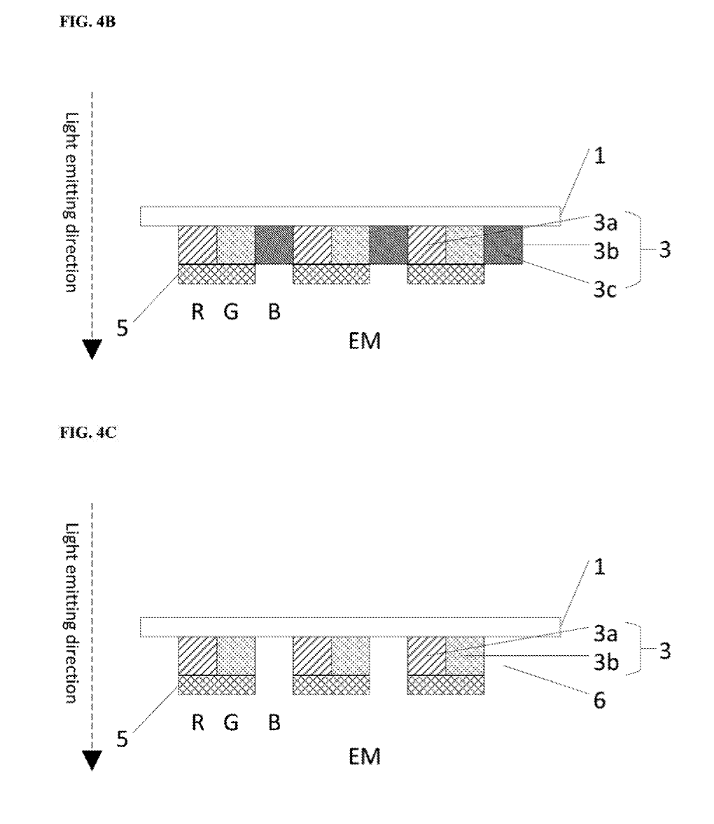

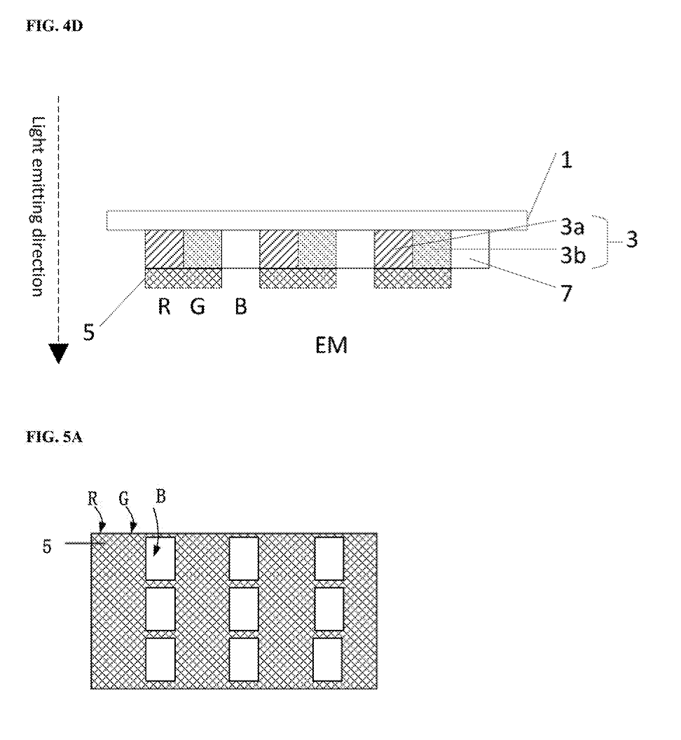

FIGS. 4A-4D are diagrams illustrating the structure of a display substrate in some embodiments. The display substrate illustrated in FIGS. 4A-4D is similar to that illustrated in FIGS. 3A-3D, except that the light filtering layer 5 and the base substrate 1 are on different sides of the quantum dot layer 3. As compared to FIGS. 3A-3D, the light emitting directions of the display substrate are reversed in FIGS. 4A-4D. As shown in FIGS. 4A-4D, the display substrate is configured so that the light of first color emitted from the at least a portion of the quantum dot layer 3 (e.g., the first quantum dot block 3a and the second quantum dot block 3b) transmits through the light filtering layer 5 for image display. The display substrate is configured so that the quantum dot layer 3 and the light filtering layer 5 are arranged upstream and downstream, respectively, relative to each other along a light emitting direction of the display substrate. The light filtering layer 5 is disposed on a side of the quantum dot layer 3 proximal to the display side EM of the display substrate. Optionally, the display substrate in FIGS. 4A-4D is an array substrate.

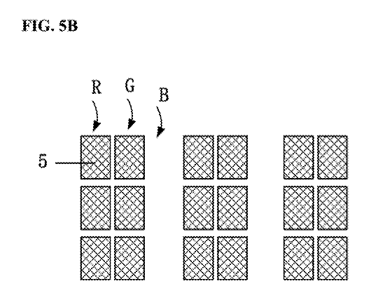

FIGS. 5A-5B are diagrams illustrating the structure of a light filtering layer in some embodiments. Referring to FIG. 5A, the light filtering layer 5 in an area corresponding to the first subpixel area R and the second subpixel area G is an integral light filtering layer, and the light filtering layer 5 is absent in an area corresponding to the third subpixel area B. Optionally, the light filtering layer 5 has a substantially uniform thickness throughout the entire layer.

Referring to FIG. 5B, the light filtering layer 5 includes a plurality of light filtering blocks spaced apart from each other. For example, the light filtering layer 5 may include a first light filtering block in an area corresponding to the first subpixel area R, and a second light filtering block in an area corresponding to the second subpixel area, the first light filtering block and the second light filtering block spaced apart from each other.

As shown in FIGS. 5A and 5B, the light filtering layer 5 completely blocks the quantum dot layer in the first subpixel area R and the second subpixel area G from receiving light of the second color provided by ambient light. Optionally, the light filtering layer 5 blocks the quantum dot layer in a portion of the first subpixel area R and in a portion of the second subpixel area G from receiving light of the second color provided by ambient light.

In another aspect, the present disclosure provides a method of fabricating a display substrate and a display panel. In some embodiments, the method of fabricating a display panel includes forming a first base substrate and a second base substrate facing each other, forming a quantum dot layer on the first base substrate; forming a light source for image display on a side of the quantum dot layer distal to the first base substrate; and forming a light filtering layer. The quantum dot layer is capable of emitting light of a first color when excited by light of a second color. The light source provides the light of the second color to the quantum dot layer for emitting the light of the first color. The light filtering layer is used for blocking at least a portion of the quantum dot layer from receiving light of the second color provided by ambient light. Accordingly, the light filtering layer is formed between the quantum dot layer and incident ambient light external to the display panel, but outside a space between the light source and the quantum dot layer.

In some embodiments, the first base substrate is a transparent base substrate; the light filtering layer is formed on a side of the quantum dot layer distal to the light source. Optionally, the light filtering layer is formed on a side of the transparent base substrate proximal to the quantum dot layer. Optionally, the light filtering layer is on a side of the transparent base substrate distal to the quantum dot layer.

In some embodiments, the second base substrate is a transparent base substrate, the light source is a light emitting layer between the first base substrate and the second base substrate; the light filtering layer is formed on the second base substrate and on a side of the light emitting layer distal to the quantum dot layer. Optionally, the light filtering layer is formed on a side of the transparent base substrate proximal to the quantum dot layer. Optionally, the light filtering layer is on a side of the transparent base substrate distal to the quantum dot layer.

In some embodiments, the method of fabricating a display substrate includes forming a quantum dot layer on a base substrate; and forming a light filtering layer, wherein the light filtering layer and the base substrate are formed on a same side of the quantum dot layer. The quantum dot layer is capable of emitting light of a first color when excited by light of a second color. The light filtering layer is used for blocking at least a portion of the quantum dot layer from receiving light of the second color provided by ambient light. Optionally, the light filtering layer is formed on a side of the base substrate proximal to the quantum dot layer. Optionally, the light filtering layer is formed on a side of the base substrate distal to the quantum dot layer.

In another aspect, the present disclosure provides a display apparatus having a display panel or display substrate described herein or fabricated by a method described herein. Examples of appropriate display apparatus include, but are not limited to, a liquid crystal display panel, an electronic paper, an organic light emitting display panel, a mobile phone, a tablet computer, a television, a monitor, a notebook computer, a digital album, a GPS, etc.

The foregoing description of the embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

1. A display substrate, comprising:
a base substrate;
a quantum dot layer on the base substrate capable of emitting light of a first color when excited by light of a second color, and
a light filtering layer for blocking at least a portion of the quantum dot layer from receiving light of the second color provided by ambient light.

2. The display substrate of claim 1, wherein the display substrate is configured so that the light of first color emitted from the at least a portion of the quantum dot layer transmits through the light filtering layer for image display.

3. The display substrate of claim 1, wherein the display substrate is configured so that the quantum dot layer and the light filtering layer are arranged upstream and downstream, respectively, relative to each other along a light emitting direction of the display substrate.

4. The display substrate of claim 1, wherein the light filtering layer and the base substrate are on different sides of the quantum dot layer.

5. The display substrate of claim 1, wherein the light filtering layer and the base substrate are on a same side of the quantum dot layer.

6. The display substrate of claim 5, wherein the light filtering layer on a side of the base substrate proximal to the quantum dot layer.

7. The display substrate of claim 5, wherein the light filtering layer on a side of the base substrate distal to the quantum dot layer.

8. The display substrate of claim 1, wherein the display substrate comprises at least a first subpixel area corresponding to a first subpixel, a second subpixel area corresponding to a second subpixel, and a third subpixel area corresponding to a third subpixel; and
the quantum dot layer comprises a first light quantum dot block corresponding to the first subpixel area capable of emitting the light of first color when excited by the light of the second color, and a second light quantum dot block corresponding to the second subpixel area capable of emitting light of a third color when excited by the light of the second color.

9. The display substrate of claim 8, wherein the light filtering layer is absent in an area corresponding to the third subpixel area.

10. The display substrate of claim 8, wherein the light filtering layer in an area corresponding to the first subpixel and the second subpixel is an integral light filtering layer having a substantially uniform thickness.

11. The display substrate of claim 1, wherein the light of the second color is blue light, the light filtering layer is a blue light filtering layer for selectively blocking blue light while allowing red light and green light passing through;
the display substrate comprises at least a red subpixel area corresponding to a red subpixel, a green subpixel area corresponding to a green subpixel, and a blue subpixel area corresponding to a blue subpixel; and
the quantum dot layer comprises a red light quantum dot block corresponding to the red subpixel area capable of emitting red light when excited by blue light, and a green light quantum dot block corresponding to the green subpixel are capable of emitting green light when excited by blue light.

12. The display substrate of claim 11, wherein the blue light filtering layer is absent in an area corresponding to the blue subpixel area.

13. The display substrate of claim 11, wherein the blue light filtering layer in an area corresponding to the red subpixel area and the green subpixel area is an integral light filtering layer having a substantially uniform thickness.

14. The display substrate of claim 11, wherein the quantum dot layer further comprises a blue light quantum dot block corresponding to the blue subpixel area capable of emitting blue light when excited by blue light.

15. The display substrate of claim 11, wherein the quantum dot layer is absent in an area corresponding to the blue subpixel area.

16. A display panel, comprising a display substrate of claim 1.

17. A display panel, comprising a first display substrate and a second display substrate facing each other;
a quantum dot layer on the first display substrate capable of emitting light of a first color when excited by light of a second color, and
a light filtering layer on the second display substrate for blocking at least a portion of the quantum dot layer from receiving light of the second color provided by ambient light.

18. The display panel of claim 17, wherein the display panel is configured so that the light of first color emitted from the at least a portion of the quantum dot layer transmits through the light filtering layer for image display.

19. The display panel of claim 17, wherein the display panel is configured so that the quantum dot layer and the light filtering layer are arranged upstream and downstream, respectively, relative to each other along a light emitting direction of the display substrate.

20. A display apparatus, comprising a display panel of claim 16.
